(19) United States
(12) Patent Application Publication
(10) Pub. No.: US 2026/0300508 A1
(43) Pub. Date: Oct. 1, 2026

(54) SYSTEM AND METHOD FOR AN ARTIFICIAL INTELLIGENCE-DRIVEN DEVELOPER EXPERIENCE FOCUSED CLOUD PLATFORM

(71) Applicant: Poddle.io Ltd, London (GB)

(72) Inventors: Rajagopalan Alathurai Raghavan, London (GB); Parthasarathi Alathurai Raghavan, Toronto (CA)

(21) Appl. No.: 19/633,490

(22) Filed: Mar. 30, 2026

Related U.S. Application Data
(60) Provisional application No. 63/781,235, filed on Mar. 31, 2025.

(51) Int. Cl. G06F 21/57

(52) U.S. Cl. CPC G06F 21/577; G06F 2221/033

(57) ABSTRACT

What is disclosed is: a method for cloud platforms using compile-time, build, run-time, corrective action, and telemetry agents. The method comprises: receiving a code commit from a version control system; the compile-time agent generating or updating a pull request (PR); summarizing the PR code and providing code review feedback; performing code quality checks; assessing security and vulnerability; the build agent compiling the source code and resolving dependencies; storing build artifacts with caching optimization; and generating and executing automated tests based on code changes. The method comprises: provisioning cloud infrastructure based on application requirements and infrastructure-as-code definitions; adaptively deploying the compiled build to the provisioned environment; provisioning domain names and digital certificates dynamically; securing and monitoring the deployed application; detecting anomalies using machine learning models; aggregating operational logs; executing self-healing operations when anomaly detection occurs; storing feedback; and using the feedback to optimize agentic actions.

### CROSS-REFERENCE TO RELATED APPLICATIONS

The embodiments herein claim the priority of the U.S. Provisional Patent Application filed on Mar. 31, 2025, with the No. 63/781,235 and titled, “AI-Driven Developer Experience focused Cloud Platform”, the contents of which are incorporated herein by reference.

### BACKGROUND

### Technical Field

The embodiments herein relate generally to software development and deployment systems and, more particularly, to systems and methods for automating build, test, deployment, infrastructure management, monitoring, and remediation operations in cloud-based software delivery environments. The embodiments herein are particularly related to a system and method for a developer experience focused cloud platform driven by artificial intelligence (AI). The embodiments herein are also related to a unified platform employing intelligent agents at compile-time, run-time, and observability stages to enable fully automated DevOps lifecycles with improved security, reliability, and efficiency.

### Description of the Related Art

Modern software delivery commonly relies on continuous integration and continuous deployment (CI/CD) pipelines that coordinate source control, dependency resolution, artifact generation, testing, infrastructure provisioning, deployment, monitoring, and incident response. In many environments, however, these operations are performed using multiple disconnected tools and often require manual configuration, review, and intervention. Areas which suffer from these issues, include but are not limited to:
Code Reviews: The prior technical solutions do not sufficiently ensure functional correctness, code quality, and maintainability, which then requires extensive human effort.
Security Assessments: The prior technical solutions are deficient in identifying and mitigating vulnerabilities (DevSecOps), thereby requiring manual scrutiny and specialized security reviews.
Testing: The failings of prior technical solutions mean that: Writing and executing functional, performance, and integration tests are time-consuming processes that may only be partially automated.
Infrastructure Provisioning & Deployment: The failings of prior technical solutions mean that: Setting up cloud infrastructure (compute, networking, storage) and performing deployments usually involve scripting and manual oversight in many organizations.
Observability & Monitoring: Configuring telemetry, monitoring systems, and analyzing logs for root cause analysis are not handled well by prior technical solutions, meaning that these are often reactive tasks that need to be handled by operations engineers.

As a result, software delivery workflows may suffer from fragmented execution context, redundant rebuild and retest operations, delayed detection of deployment-induced anomalies, inconsistent infrastructure changes, and slower corrective action in production environments. Valuable developer and operator time is spent on repetitive tasks, leading to increased costs and slower delivery cycles.

Existing automation solutions tend to focus on isolated aspects of DevOps (for example, CI pipeline tools, separate security scanners, or standalone infrastructure orchestrators) rather than offering a fully integrated, AI-powered approach that covers the end-to-end lifecycle. Consequently, such systems may be less effective at correlating code changes with downstream deployment behavior, selecting responsive deployment or remediation actions, and improving subsequent build, test, infrastructure, and monitoring operations based on prior outcomes.

Accordingly, a need exists for improved techniques for coordinating and automating software delivery operations across compile-time, deployment-time, and run-time stages, including techniques for integrating code analysis, dependency-aware build operations, test generation and execution, infrastructure control, telemetry-driven anomaly detection, and corrective action within a unified platform.

The AI-Driven Agentic DevOps Platform provides an end-to-end solution that automates the entire software development lifecycle through an integrated, agentic framework. As would be known to one of ordinary skill in the art, an agent refers to an intelligent AI-driven entity, automated software system, or hybrid automation process designed to autonomously execute specific tasks within the software development and delivery lifecycle. Agents operate independently or collaboratively, employing adaptive learning, predictive analytics, and automated workflows to significantly reduce manual intervention, enhance productivity, and maintain consistent compliance, reliability, and efficiency throughout DevOps processes. By providing an integrated framework using intelligent agents, the platform addresses the shortcomings of prior technical solutions, thus reducing the need for manual intervention. The platform significantly reduces turnaround time from code commit to production deployment while maintaining a high degree of confidence in system correctness, security, and performance.

Furthermore, the AI-Driven Agentic DevOps Platform has an important advantage over prior technical solutions: the agents and models are able to learn, train, and therefore adjust and adapt, enabling continuous improvement, reduced error rates, and therefore enhanced accuracy. The lack of adaptation capabilities in the prior technical solutions meant that error rates from faulty or inaccurate outputs would remain high, thereby degrading performance.

The above-mentioned shortcomings, disadvantages, and problems are addressed herein, and which will be understood by reading and studying the following specification.

### OBJECT OF THE EMBODIMENTS HEREIN

The primary object of the embodiments herein is to provide a system and method for a unified AI-driven developer experience focused cloud platform.

Another object of the embodiments herein is to provide a modular agent-based architecture comprising compile-time, run-time, and observability agents working collaboratively to automate the software delivery lifecycle.

Yet another object of the embodiments herein is to provide automated pull request creation, code quality assessment, and security scanning at compile-time.

Yet another object of the embodiments herein is to provide AI-driven infrastructure provisioning, deployment strategy selection, and run-time security enforcement.

Yet another object of the embodiments herein is to provide a self-healing mechanism capable of detecting anomalies and executing corrective actions without human intervention.

Yet another object of the embodiments herein is to provide continuous observability and telemetry feedback loops that inform and optimize future development, testing, and deployment activities.

Yet another object of the embodiments herein is to improve developer productivity, reduce operational costs, and increase software reliability by minimizing human-driven repetitive DevOps processes.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The systems and methods described below introduce a novel AI-driven delivery framework that employs intelligent agents at both compile-time and run-time to perform and optimize DevOps tasks. Key features of the platform include:
Automated Pull Request (PR) Management and Code Quality Assessment: The system uses AI agents to detect code changes, generate structured pull requests, enforce coding standards, and ensure compliance with repository guidelines automatically.
AI-Powered Security and Vulnerability Detection: Security agents perform continuous code scanning and dependency analysis during development, as well as run-time threat detection in deployed environments, to identify vulnerabilities and compliance issues early.
Dynamic Infrastructure Provisioning and Workload Optimization: Intelligent run-time agents manage cloud resources, automatically provisioning or adjusting compute, storage, and networking configurations based on application needs and predefined policies for cost and performance optimization.
Real-Time Monitoring, Observability, and Self-Healing: The platform provides enhanced observability through AI-driven telemetry. Agents continuously monitor application performance and health metrics, detect anomalies or failures in real time, and can proactively trigger self-healing actions (such as automatic rollbacks, restarts, or scaling operations).
Seamless Integration from IDE to Cloud: The systems and methods described below ensure a continuous, optimized developer experience by integrating with development environments (e.g., IDEs) for feedback and suggestions, through CI/CD pipelines, and into cloud deployment and monitoring. This creates a unified pipeline from the moment code is written to its execution in production.
By implementing these capabilities in a unified platform, the described systems and methods eliminate traditional DevOps bottlenecks. The disclosed platform addresses technical problems arising in cloud-based software delivery environments, including fragmented execution context across build, deployment, and monitoring stages, redundant rebuild computation, delayed identification of deployment-induced anomalies, and slower or inconsistent run-time remediation. Developers and operations teams are freed from many repetitive tasks, leading to faster deployment frequencies and lower operational costs. The intelligent agents operate with adaptive learning capabilities, enabling the system to evolve based on development patterns and operational insights. As a result, the platform enhances developer productivity, enforces security compliance, and improves software reliability and uptime.

According to one embodiment herein, a system is provided comprising: a compile-time agent module (101) configured to receive source code commits, generate structured pull requests, perform automated code quality checks, validate non-functional requirements, and execute security scans; a build and dependency management module (102) configured to compile code, resolve dependencies, and apply caching to improve build efficiency; a test orchestration module (103) configured to generate and execute automated unit, integration, and performance tests using synthetic data; a run-time agent module (104) configured to provision infrastructure using infrastructure-as-code templates, deploy application builds using adaptive deployment strategies, and configure run-time security and network policies; a preview environment module (105) configured to create ephemeral, production-like environments for validation; an observability and telemetry module (106) configured to monitor application and infrastructure metrics in real time, aggregate logs, detect anomalies, and identify root causes; a self-healing agent module (107) configured to execute corrective actions including rollback, redeployment, restarts, and scaling in response to detected issues; and, a feedback loop module (108) configured to capture and store operational insights in a shared context memory, using them to refine future agent actions.

According to another embodiment herein, a method for AI-driven DevOps automation is provided comprising the steps of: receiving a code commit; generating a pull request and performing automated code review and security scanning; compiling the code and managing dependencies; generating and executing automated tests; provisioning and configuring cloud infrastructure; deploying the application build using adaptive strategies; monitoring the deployment in real time and detecting anomalies; executing self-healing actions; and, feeding operational data back into the shared memory context for continuous optimization.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1 illustrates the overall system architecture of the AI-driven developer experience focused cloud platform, according to one embodiment herein.

FIG. 2 illustrates the compile-time agent module and its functional workflow, according to one embodiment herein.

FIG. 3 illustrates the run-time agent module and its functional workflow, according to one embodiment herein.

FIG. 4 illustrates a functional block diagram of a system for end-to-end automation of a software delivery lifecycle using an agent-based platform, according to one embodiment herein.

Although the specific features of the embodiments herein are shown in some drawings and not in others. This is done for convenience only, as each feature may be combined with any or all of the other features in accordance with the embodiment herein.

### DETAILED DESCRIPTION

The systems and methods below describe a collection of AI-driven agents and an underlying framework that together automate the various stages of software development and delivery. The architecture is divided broadly into three categories of agents and an underlying framework:
Compile-Time Agents: Responsible for activities during the development and build phase, such as code quality enforcement, security checks, test generation, and other pre-deployment verifications.
Run-Time Agents: Responsible for operations during and after deployment, including infrastructure provisioning, application deployment, rollback handling in production.
Observability and Self-Optimization Agents: Responsible for telemetry collection, logging, run-time security, anomaly detection, performance monitoring, self-healing and system reliability through continuous monitoring.
An Underlying Framework: A cross cutting underlying framework that orchestrates and manages the three type of agents and handles the end-to-end workflow.

Compile-Time Automation: At compile-time (or build/test time), the platform employs several specialized agents to streamline development tasks and enforce quality before code is merged and deployed:
Automated Build and Dependency Resolution: A build agent intelligently detects code changes in the repository, triggers appropriate build processes, resolves dependencies, and generates build artifacts. It optimizes performance by caching intermediate results and reusing them for subsequent builds, thus reducing build times and resource usage.
Pull Request (PR) Management and Quality Control: An AI-powered PR automation agent creates and manages pull requests. It ensures that each PR is well-formed and adheres to repository standards (e.g., proper description, linked issue tickets). Additionally, code quality agents automatically review the code changes for style compliance, potential bugs, and adherence to architectural guidelines.
Code Quality and Non-Functional Requirements (NFR) Validation: Advanced static analysis is performed by code quality agents to enforce maintainability and security standards. For example, the agent runs linters, complexity analyzers, and static security scanners on new code. It checks non-functional requirements such as performance (complexity, resource usage heuristics) and security (e.g., no use of banned APIs, injection flaws) to prevent issues from entering the codebase.
Synthetic Data Generation and Automated Test Execution: AI-driven test generation agents analyze code changes and predict or generate the necessary test cases to achieve adequate coverage. They can produce synthetic input data (using learned patterns or state stored in an agent memory) for testing edge cases and typical scenarios. Automated test execution agents then run unit tests, integration tests, and performance tests in an isolated environment. This ensures that each code change is validated against regressions or unmet requirements before integration.
   These compile-time agents collectively ensure that by the time code is merged into the main branch, it has been thoroughly vetted for quality, security, and functionality with minimal human intervention. The result is a significant reduction in defects and rework, saving time and cost in the development process.

Run-Time Automation: Once the software passes the compile-time phase and is ready for deployment, run-time agents take over to automate the release and operations tasks:
Automated Infrastructure Provisioning: Infrastructure provisioning agents dynamically allocate and configure cloud resources (such as virtual machines, containers, serverless functions, databases, and networking components) based on the application's requirements. Using infrastructure-as-code templates and AI planning, the agent can determine the optimal resource allocation (for example, the right size of compute instance or the appropriate number of replicas) to meet current demand while minimizing cost.
Intelligent Deployment and Release Management: Deployment agents handle the rollout of application builds to staging and production environments. They support strategies like blue-green deployments, canary releases, or rolling updates automatically. The agent can decide, based on policy and real-time feedback, whether to promote a deployment or rollback if issues are detected, thus safeguarding reliability during releases.
Preview Environments: Agents dynamically provision ephemeral, isolated preview environments corresponding to each code change or pull request, enabling developers and QA teams to thoroughly test and validate functionality, integration, and user experience in realistic, production-like conditions. These preview environments replicate exact deployment settings, facilitating early detection of integration issues, performance bottlenecks, or regressions before merging the code into the main branch. This approach significantly enhances code quality, accelerates feedback loops, and reduces risk, leading to more stable and reliable software releases.
Automated Security, Network & Firewalls Configuration: Security and network agents autonomously enforce and maintain security policies by dynamically adjusting firewall rules, network configurations, and access controls based on real-time application behavior analysis and integrated threat intelligence data. These agents continuously monitor network traffic, application patterns, and external threat feeds to proactively identify and remediate potential vulnerabilities, unauthorized access attempts, or anomalous activities. The agents significantly reduce the time required to secure cloud infrastructure, minimizing errors, enhancing overall security posture, and ensuring continuous compliance with best-practice security standards when compared to prior technical solutions.
   By automating run-time operations, the platform overcomes the problems of prior technical solutions, and thereby reduces the need for on-call firefighting and manual operational work. This leads to lower labor costs in operations and improved consistency in how incidents are handled (the agent responds immediately according to pre-defined best practices every time).

Observability and Monitoring Automation: Once the software is deployed to production, observability and monitoring agents are used to ensure reliability:
Real-Time Observability, Monitoring, and Telemetry: Telemetry agents continuously monitor deployed applications and infrastructure in real time. They collect metrics such as response times, error rates, throughput, and resource utilization. Using machine learning (ML) algorithms such as, for example, anomaly detection algorithms, these agents identify deviations from normal behavior that might indicate performance issues or incidents. For instance, the agent might detect memory leaks or increasing error rates and flag them before they cause outages. Algorithms to detect anomalies are well known to those of ordinary skill in the art.
Log Management and Root Cause Analysis: Log collection agents aggregate and centralize logs from various services and infrastructure components. They structure and label log data to make it searchable. An AI-driven analysis module can then sift through logs to correlate events and pinpoint the root cause of issues. For security use cases, the same data can be used by security agents to detect suspicious activities or intrusion patterns in real time.
Self-Healing Capabilities: Perhaps one of the most critical features, run-time agents provide self-healing by autonomously triggering corrective actions when problems are detected. For example, if an application instance becomes unresponsive or its health checks fail, an agent can automatically replace it (restart a container or launch a new instance). If a new deployment causes widespread errors, the agent can roll back to a stable version without waiting for human intervention. Other self-healing responses include auto-scaling resources when load spikes, clearing caches, or adjusting configurations. These actions dramatically improve system reliability and uptime by reducing mean-time-to-recovery (MTTR) when incidents occur.
   The observability agents ensures that the platform not only reacts to issues but also learns from every incident and developer interaction to become more efficient and effective over time. This introduces a self-optimizing feedback loop into the DevOps pipeline, where insights from operations feed back into development (for example, highlighting code areas that frequently cause run-time errors), and vice versa (development practices feed into better operational setups).

Agentic Framework for DevOps: The Agentic DevOps framework comprises compile-time, run-time, and observability & monitoring agents leveraging a modular agentic architecture. Key architectural elements include an agent run-time engine, memory stores for state retention, integration with external development and operations tools, and chain-of-thought reasoning modules enabling multi-step, complex decision-making. This modular design ensures agents are intelligent, scalable, independently upgradable, and capable of seamless interaction and collaboration.

Compile-Time Agents (quality & developer experience-focused), Run-Time Agents (infrastructure & security-focused), and Observability & Monitoring Agents (real-time issue detection and self-healing-focused) operate collaboratively through shared memory or messaging mechanisms. This interconnected design ensures efficient information handover and operational coherence throughout the software lifecycle.

The framework's hybrid AI approach enables autonomous execution of routine tasks while integrating human oversight and decision-making for exceptional scenarios, ensuring balanced automation trusted by enterprises.

Architectural Workflow: The following is an example of the end-to-end automation pipeline as orchestrated by the platform. It details each stage of the software delivery process and the corresponding agents involved in that stage:
Code Commit Stage: A developer checks in code changes to a version control repository. The PR Automation Agent immediately detects the change and creates a pull request, tagging relevant reviewers or linking to issue trackers as needed. Simultaneously, Code Quality Agents run in the background to validate that the new changes adhere to coding standards and do not violate any predefined rules (such as style guides or complexity thresholds). The output of these agents (e.g., code review comments or pass/fail status) is attached to the pull request for reviewers to see.
Build Stage: Upon pull request approval or an integration trigger, Build Agents integrate with existing CI tools to compile the code and build artifacts (binaries, containers, etc.). If any dependencies are introduced or updated, the agent fetches and caches them efficiently. In parallel, Test Generation Agents use templates and learned project knowledge to create necessary test cases, and Mock Data Agents supply synthetic data for those tests. These agents ensure the build is not only compiled but also ready for thorough testing.
Testing Stage: During continuous integration, Test Run Agents execute the suite of unit tests and functional tests using the provided test cases and data. They coordinate with testing frameworks or cloud testing services as needed. Additionally, Functional Test Agents might perform higher-level testing such as UI tests or API endpoint validations, using tool integrations (for example, triggering a Selenium test suite or Postman API tests). If any test fails, the agents log the defects and can even halt the pipeline for fixes, providing detailed diagnostics.
Deployment Stage: Once all tests pass and the build is deemed release-ready, Infrastructure Provisioning Agents automatically set up the required target environment. This could mean allocating servers or deploying to a Kubernetes cluster, configuring load balancers, or preparing database instances. After provisioning, a Deployment Agent (as part of run-time agents) handles the actual deployment of the new version onto the infrastructure. This agent monitors the deployment process for any issues (like failing health checks).
Monitoring Stage: After deployment, the system transitions to continuous monitoring. Telemetry Agents track key metrics (latency, error rates, throughput, resource usage) and use AI models to detect anomalies or performance regressions in real time. Log Collection Agents gather logs from the application and infrastructure, feeding them to the central analysis system. Security Agents (as part of run-time) continuously scan the environment for security anomalies or intrusions (for example, using intrusion detection systems data, audit logs, or unusual pattern detection in network traffic). If any irregularity is detected by these monitoring agents, alerts are generated and passed to the self-healing mechanism or to human operators, depending on severity.
Each stage of this workflow is connected to the others in a feedback loop. For instance, insights from the Monitoring Stage (like a performance bottleneck identified by telemetry) can be fed back into the Code Commit Stage in the form of a new issue or improvement suggestion for developers (possibly even creating an automated pull request to optimize code or configurations). This end-to-end pipeline, powered by the agentic framework, ensures that the path from code creation to code running in production is as automated and optimized as possible, with minimal wasted effort or delay.

Use Case Scenarios: The following scenarios illustrate how the unified DevOps platform can be applied across various industries and team contexts to save time and enhance reliability when compared to prior technical solutions:
Enterprise Software Development Teams: Large development teams at enterprises can use the platform to automate code quality control, security checks, and deployment processes. This leads to consistent enforcement of corporate coding standards and security policies across all projects. By reducing error, enterprises can achieve faster release cycles and more reliable production systems when compared to prior technical solutions.
Continuous Deployment in FinTech: FinTech applications require rapid deployment of new features while maintaining strict security and compliance (e.g., financial regulations). The platform's security agents automatically perform fraud detection checks and enforce compliance rules (such as PCI-DSS for payment data) during both compile-time and run-time. Continuous monitoring ensures any anomaly in transactions or system behavior is immediately flagged. This allows FinTech organizations to deploy updates continuously with confidence that compliance and security are not compromised, all while minimizing the need for a large DevOps staff.
AI-Driven DevSecOps for Healthcare: Healthcare applications must adhere to regulations like HIPAA (in the US) and other patient data protection laws globally. The platform provides HIPAA-compliant security enforcement by automatically scanning code for compliance with privacy requirements, managing infrastructure with proper encryption and access controls, and continuously monitoring for any security breach or data leak in real time. For example, if a piece of code introduces a way to access sensitive patient data without proper encryption, the security agent would catch it at compile-time. In production, the observability framework monitors access patterns to detect any unauthorized access. This scenario highlights how the platform reduces risk and cost in highly regulated environments, compared to prior technical solutions.
Cloud-Native Startups Scaling Rapidly: Startups that experience rapid user growth can leverage the platform to handle scale without a large ops team. The infrastructure agents automatically provision and scale cloud resources as traffic increases, ensuring performance is maintained. Cost optimization is achieved by de-provisioning resources during low usage periods and selecting the most cost-effective resource types for the workload. The development team at the startup can focus on building features, knowing that the DevOps pipeline—from testing to deployment to monitoring—is largely self-managing. This reduces the need to hire dedicated DevOps engineers early on, saving cost while still following best practices for reliability.
   These use cases demonstrate the versatility of the systems and methods described below in addressing DevOps challenges across different contexts. In each scenario, the common theme is that the AI-driven unified platform reduces cost and error, speeds up delivery, and enforces security and compliance when compared to prior technical solutions. The AI-driven unified platform has the advantage over prior technical solutions of being able to adapt to the needs of the environment automatically.

The Agentic DevOps Platform offers several distinct advantages over traditional DevOps toolchains and practices:
Increased Speed and Efficiency: By automating software delivery tasks (builds, tests, deployments), the platform significantly speeds up development cycles and improves time-to-market for new features when compared to prior technical solutions.
Enhanced Security and Compliance: AI-driven security assessments at multiple stages prevent vulnerabilities from reaching production. The platform enforces compliance with security standards and regulatory requirements automatically, reducing the risk of security incidents and compliance violations.
Improved Developer Productivity: Developers are relieved from routine DevOps chores such as writing boilerplate tests, configuring pipelines, or fixing minor code style issues. Automated pull requests, code quality checks, and test case generation reduce cognitive load and context-switching, allowing developers to focus more on creative tasks and core application logic.
Scalability and Cost Optimization: The dynamic resource allocation by infrastructure agents ensures efficient cloud cost management. Systems can scale out to handle high load and scale in during off-peak times, optimizing usage of resources and lowering infrastructure cost.
Continuous Observability and Resilience: Proactive anomaly detection and AI-driven observability improve system resilience by catching issues early. The self-healing mechanisms reduce downtime by responding to failures instantly. This leads to higher uptime and more stable applications, which is critical for user trust and revenue continuity.
Collectively, these advantages translate to a DevOps environment that wastes far fewer resources. Time that would be spent waiting for approvals or fighting fires is instead used for productive development. Constant automated checks minimize human errors that could lead to costly downtime or security breaches. Organizations adopting these systems and methods can achieve a competitive edge through faster delivery of features at higher quality and with lower overhead.

The Agentic DevOps Platform for engineering delivery represents a bottom-up approach to software development automation, ensuring that DevOps optimizations start at the server/cloud level and extend all the way to the developer's IDE. The described agent-based framework provides an integrated ecosystem of compile-time and run-time agents that together enhance security, reliability, efficiency, and scalability across the entire software lifecycle. By automating both the Compile-Time workflows and the Run-Time workflows, along with observability & telemetry, the described systems and methods create a continuous delivery pipeline with unprecedented levels of automation and intelligence. This not only reduces wasted effort and time in the development process but also ensures a high level of compliance with best practices and resilience in operations. The platform is designed to be extensible and adaptable, supporting future expansion and integration with emerging technologies, and it lays a strong foundation for organizations to embrace fully autonomous DevOps on a global scale.

According to one embodiment herein, a system for end-to-end automation of a software delivery lifecycle using an agent-based platform comprises a compile-time module, further comprising a plurality of agents configured to receive source code commits from a version control system, generate and update structured pull requests to review and summarize code, perform code quality and complexity checks, analyze security vulnerabilities, and generate and suggest test cases based on code changes and learned patterns; a build and dependency management module configured to compile source code into build artifacts, resolve software dependencies, and apply intelligent caching strategies to reduce build time and resource utilization; a test orchestration and execution module configured to execute generated and user-defined unit, integration, automation, and performance tests in an isolated environment, and enforce code coverage thresholds and quality gates based on predefined policies; a run-time module comprising a plurality of agents configured to dynamically provision cloud infrastructure using infrastructure-as-code templates, deploy application builds using intelligent strategies, configure domain names to effectively access the deployed applications, apply real-time security configurations including firewall rules, access policies, and rate limiters to prevent DDoS attacks, and provision SSL certificates dynamically to ensure encryption; a preview environment module configured to provision ephemeral staging environments corresponding to pull requests or feature branches, and automatically de-provision such environments upon validation; an observability and telemetry module configured to collect runtime application performance metrics and infrastructure metrics, collect and analyze different logs such as system logs, application logs, and request/response logs, detect anomalies using machine learning models, and generate operational alerts based on deviations from normal behavior; a security module configured to analyze different logs to capture security incidents and alert regarding potential security threats and attacks; a self-healing module comprising a plurality of agents configured to execute corrective actions including rollback, redeployment, container restarts, and resource scaling in response to detected anomalies or policy violations; and a feedback loop module configured to store runtime analytics, test trends, and operational insights in a shared memory context, and use the stored context to refine future pull requests, test generation, and infrastructure provisioning decisions, wherein the system enables continuous, automated software delivery, enhanced code quality, real-time monitoring, and predictive infrastructure and security management.

According to one embodiment herein, the compile-time module further comprises a pull request automation agent configured to tag reviewers, label issues, and insert comments regarding coding guideline violations and architectural deviations.

According to one embodiment herein, the build and dependency management module is configured to identify reusable build artifacts using signature matching and avoid redundant rebuilds for unchanged modules.

According to one embodiment herein, the test orchestration module further comprises a test generation agent configured to analyze recent code changes and historical defect patterns to generate additional regression test cases.

According to one embodiment herein, the run-time agent module is configured to select deployment strategies from blue-green, canary, or rolling updates based on application type, error budget, and user traffic profiles.

According to one embodiment herein, the preview environment module is configured to simulate production-like conditions, including user permissions, API endpoints, and network configurations for pre-release validation.

According to one embodiment herein, the observability and telemetry module comprises a telemetry agent configured to monitor key metrics, including latency, throughput, memory usage, and error rates, and to raise alerts when predefined thresholds are crossed.

According to one embodiment herein, the self-healing agent module is configured to initiate automated rollbacks to the last known stable version upon detection of a deployment-induced anomaly with elevated error rates or failed health checks.

According to one embodiment herein, the feedback loop module is configured to update the shared memory context with metadata from successful pull requests, failed deployments, and run-time incidents, and influence future agentic decision-making processes.

According to one embodiment of the present systems and methods, a method for end-to-end automation of a software delivery lifecycle using an agent-based platform comprises receiving a code commit event from a version control system; generating or updating a pull request using a compile-time agent, summarizing the code in the pull request and providing inline code review feedback, performing code quality checks and static security and vulnerability assessments; compiling the source code and resolving dependencies using a build agent, and storing build artifacts with caching optimization; generating and executing automated tests using a test orchestration and execution module, the tests including unit, integration, automation, and performance scenarios based on code changes; provisioning cloud infrastructure using a run-time agent, the provisioning based on application requirements and infrastructure-as-code definitions; deploying the compiled build to the provisioned environment using an adaptive deployment strategy; provisioning domain names and SSL certificates dynamically; securing the deployed application through predefined policies and firewall rules; monitoring the deployed application using a telemetry agent, detecting anomalies using machine learning models, and aggregating operational logs; executing self-healing operations using a corrective action agent in response to run-time anomalies; and feeding operational and test feedback into a shared context memory, and using the feedback to optimize future agentic actions in the software delivery lifecycle.

According to one embodiment herein, the step of generating a pull request further comprises executing a code quality agent that evaluates style conformance, cyclomatic complexity, and non-functional requirements.

According to one embodiment herein, the step of compiling the source code includes detecting changed files, identifying impacted modules, and skipping redundant builds using intelligent dependency caching.

According to one embodiment herein, the step of generating automated tests further comprises analyzing historical bug trends and using synthetic data agents to generate high-risk edge-case scenarios.

According to one embodiment herein, the step of provisioning cloud infrastructure further comprises selecting resource configurations that balance compute efficiency and cost constraints, based on telemetry-informed provisioning heuristics.

According to one embodiment herein, the step of deploying the build further comprises selecting a deployment strategy from a group comprising canary, blue-green, and rolling updates, based on deployment policy and live traffic load.

According to one embodiment herein, the step of monitoring comprises collecting and analyzing metrics, including API latency, system throughput, error rates, and memory footprint using telemetry agents.

According to one embodiment herein, the step of executing self-healing operations includes initiating automated rollback to a prior release, restarting affected applications or infrastructure, and provisioning additional infrastructure.

According to one embodiment herein, the step of feeding feedback into shared context comprises storing metadata including test coverage gaps, code modules with frequent rollbacks, and infrastructure scaling events, and adjusting future pull request review strategies and provisioning logic accordingly.

According to one embodiment herein, the agentic framework comprises one or more machine learning and language models configured to process structured and unstructured data associated with software development workflows, wherein the models are trained using historical repository data, build logs, test results, deployment outcomes, and run-time telemetry to generate predictive and prescriptive outputs for DevOps automation tasks. The models operate on feature representations including code complexity metrics, dependency graphs, execution traces, error patterns, and infrastructure utilization parameters, thereby enabling data-driven decision making across compile-time, run-time, and observability stages.

According to one embodiment herein, the anomaly detection functionality implemented within the observability and telemetry module comprises statistical and machine learning based models configured to identify deviations from learned baseline behavior, wherein the baseline behavior is established using historical performance metrics, including latency, throughput, memory consumption, and error rates. The anomaly detection models generate anomaly scores based on deviation thresholds and temporal patterns, and trigger corresponding alerts or corrective actions when the anomaly scores exceed predefined limits.

According to one embodiment herein, the test generation agent utilizes one or more trained models configured to analyze code changes, historical defect patterns, and execution paths to generate test cases, wherein the generated test cases comprise input conditions, expected outputs, and edge case scenarios derived from learned correlations between code structures and defect occurrences. The models further utilize synthetic data generation techniques to produce input datasets that simulate realistic and boundary conditions, thereby improving test coverage and defect detection capability.

According to one embodiment herein, the infrastructure provisioning and deployment agents utilize predictive models configured to determine optimal resource configurations and deployment strategies, wherein the models are trained on historical deployment data, including success rates, rollback occurrences, traffic patterns, and resource utilization metrics. The models output provisioning parameters, including instance types, scaling thresholds, and deployment strategies selected from canary, blue-green, and rolling deployments based on predicted system behavior and risk profiles.

According to one embodiment herein, the feedback loop module maintains a shared context memory comprising structured representations of prior system states, agent actions, and outcomes, wherein the memory is used as input to continuously update and refine the machine learning models. The refinement process comprises updating model parameters based on observed discrepancies between predicted outcomes and actual outcomes, thereby enabling continuous learning and improvement of agent decision making over time.

According to one embodiment herein, the system implements a hybrid execution model wherein automated agent decisions generated by the machine learning models are subjected to policy constraints and optional human validation for predefined critical operations, thereby ensuring controlled deployment of AI-driven actions while maintaining system safety, reliability, and compliance with operational requirements.

According to one embodiment herein, each machine learning component is executed on a computing infrastructure comprising processors, memory, and storage, wherein the processors execute instructions to perform data preprocessing, feature extraction, model inference, and output generation, and wherein the outputs directly control downstream system operations including code validation, test execution, infrastructure provisioning, deployment actions, and run-time remediation, thereby producing tangible technical effects in a computing environment.

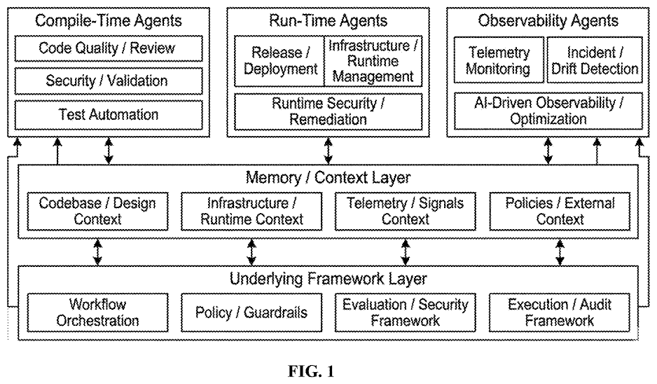

FIG. 1 illustrates the overall system architecture of the AI-driven developer experience-focused cloud platform, according to one embodiment herein.

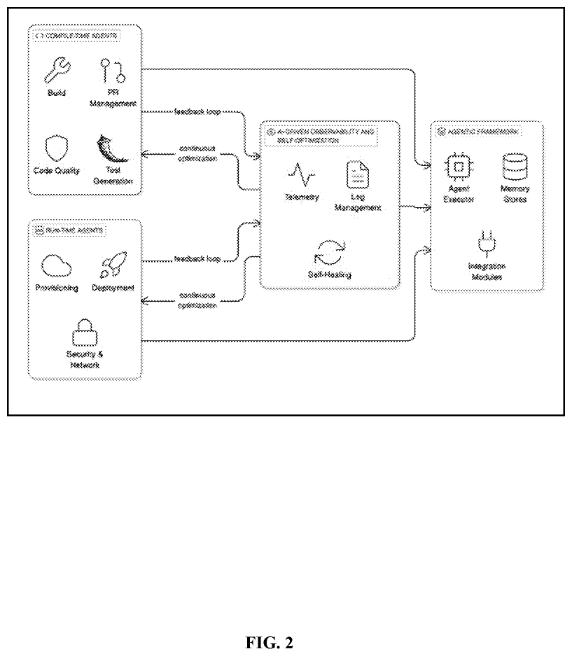

FIG. 2 illustrates the compile-time agent module and its functional workflow, according to one embodiment herein.

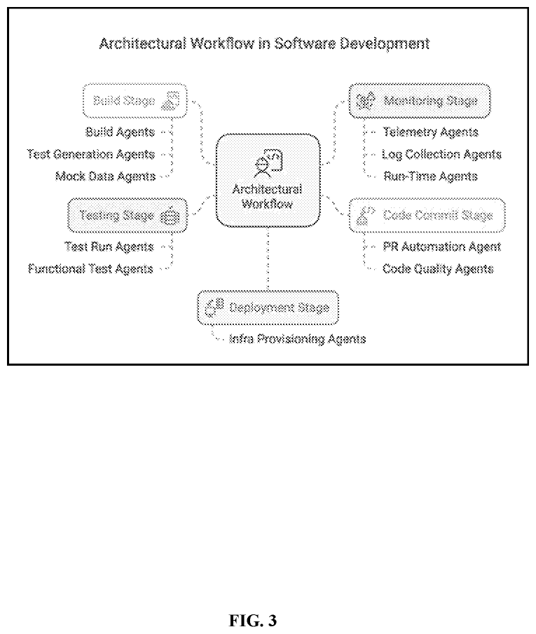

FIG. 3 illustrates the run-time agent module and its functional workflow, according to one embodiment herein.

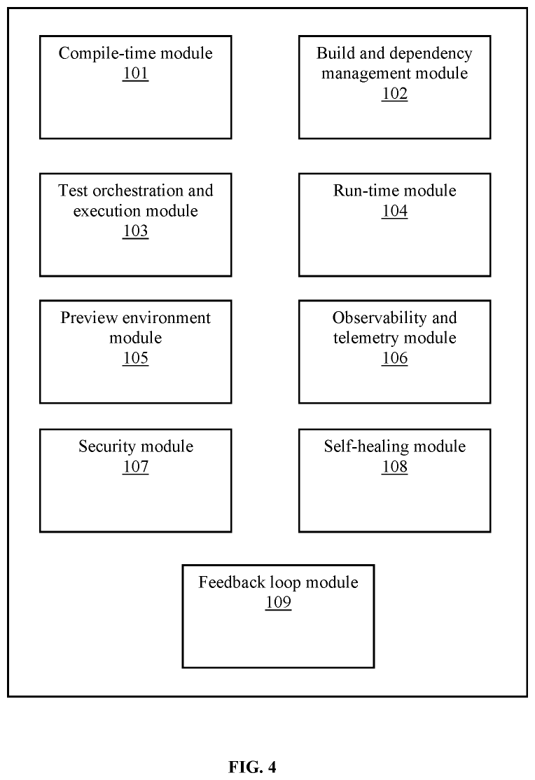

FIG. 4 illustrates a functional block diagram of a system for end-to-end automation of a software delivery lifecycle using an agent-based platform. The system comprises a compile-time module 101, a build and dependency management module 102, a test orchestration and execution module 103, a run-time module 104, a preview environment module 105, an observability and telemetry module 106, a security module 107, a self-healing module 108, and a feedback loop module 109.

One of ordinary skill in the art would recognize that the modules described above can be implemented in a variety of ways. In some embodiments, one or more of the modules described above are implemented in hardware. In yet other embodiments, one or more of the modules described above are implemented in software. In yet other embodiments, one or more of the modules described above are implemented using a combination of hardware and software. In some of these embodiments, one or more of the modules are implemented using one or more processors executing instructions stored in one or more non-transitory memory or storage units, wherein the one or more processors are coupled to the one or more non-transitory memory or storage units.

One of ordinary skill in the art would understand that in some embodiments, one or more of the modules described above are implemented using one or more private clouds. In other embodiments, one or more of the modules described above are implemented using one or more public clouds. In yet other embodiments, one or more of the modules described above are hosted by a third-party cloud services provider.

The modules may be implemented on or across one or more suitable computing devices, components, and subsystems, including but not limited to servers, virtual machines, containers, nodes, edge devices, gateways, client devices, or orchestration controllers.

One of ordinary skill in the art would also understand that: in some embodiments the modules described above are communicatively coupled to each other using known communication and networking technologies and interfaces so as to establish suitable connections between the modules. In some embodiments, this is achieved using wired communication technologies. In other embodiments, this is achieved using wireless communication technologies. In yet other embodiments, this is achieved using a combination of wired and wireless communications technologies.

The above paragraphs describe training, learning, adjustment and/or adaptation of one or more models or agents using, for example, historical data and feedback. In addition, training, learning, and/or adaptation may use any other suitable data, including live operational data, synthetic data, simulated data, user-provided data, labeled data, unlabeled data, and data derived from prior actions, outcomes, or stored context. Training or learning may be performed using any suitable technique, including supervised, unsupervised, semi-supervised, self-supervised, reinforcement, gradient-based training or learning techniques such as the method of steepest descent, or transfer learning, as well as fine-tuning of a pre-trained model. Such training, learning, or adaptation may occur before deployment, during deployment, online, offline, periodically, continuously, or on demand. As one of ordinary skill in the art would understand, an AI or ML agent, or model or algorithm associated with the agent, experiences improvement in one or more performance metrics due to appropriate learning or training. Then, by iteratively performing learning or training, one or more performance metrics of the agent, or model or algorithm associated with the agent, continually improve. This is a technical enhancement in performance relative to non-adaptive prior technical solutions.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the disclosure with modifications. However, all such modifications are deemed to be within the scope of the appended claims.

It is also to be understood that the following claims are intended to cover all of the generic and specific features of the embodiments described herein and all the statements of the scope of the embodiments, which, as a matter of language, might be said to fall there between.

What is claimed is:

1. A system for controlling software build, deployment, monitoring, and remediation operations in a cloud computing environment, the system comprising:
one or more processors communicatively coupled to a non-transitory memory, wherein the non-transitory memory stores instructions; and
the one or more processors execute the instructions to:
implement a first plurality of agents, wherein the first plurality of agents:
receives source code commits from a version control system,
generates and updates structured pull requests to review code and summarize,
performs code quality and complexity checks,
analyzes security vulnerabilities, and
generates and suggests test cases based on code changes and learned patterns,
compile source code into build artifacts,
resolve software dependencies,
apply intelligent caching strategies,
execute generated and user-defined unit, integration, automation, and performance tests in an isolated environment,
enforce code coverage thresholds and quality gates based on predefined policies,
implement a second plurality of agents, wherein the second plurality of agents:
dynamically provisions cloud infrastructure based on infrastructure-as-code templates,
deploys application builds using intelligent strategies,
configures domain names to access the deployed applications,
applies real-time security settings comprising:
one or more firewall rules,
one or more access policies,
one or more rate-limiting settings, and
digital certificates,
provision an ephemeral staging environment corresponding to a pull request or a feature branch,
de-provision the ephemeral staging environment upon validation,
collect run-time application performance metrics and infrastructure metrics,
collect and analyze a first one or more logs comprising system logs, application logs, and request-response logs associated with the deployed application,
detect anomalies based on the collected metrics and logs using one or more trained machine-learning models,
generate operational alerts in response to deviations from a baseline behavior,
analyze a second one or more logs to identify potential security incidents and generate security alerts,
execute corrective actions in response to a detected anomaly or a policy violation,
store run-time analytics, test trends, and operational insights in a shared memory context,
use the shared memory context to refine subsequent pull requests, generate tests and make infrastructure provisioning decisions.

2. The system of claim 1, wherein:
the first plurality of agents comprises a pull request automation agent;
the pull request automation agent tags reviewers and label issues; and
the pull request automation agent inserts comments related to coding guideline violations and architecture deviations.

3. The system of claim 1, wherein the one or more processors execute the instructions to:
identify reusable build artifacts using signature matching, and
avoid redundant rebuilds for unchanged modules.

4. The system of claim 1, wherein the one or more processors execute the instructions to:
implement a test generation agent to analyze recent code changes and historical defect patterns to generate additional regression test cases.

5. The system of claim 1, wherein the second plurality of agents selects deployment strategies based on application type, error budget, and user traffic profiles.

6. The system of claim 1, wherein the one or more processors execute the instructions to simulate production conditions comprising:
user permissions,
API endpoints, and
network configurations for pre-release validation.

7. The system of claim 1, wherein:
the one or more processors execute the instructions to implement a telemetry agent;
the telemetry agent monitors metrics comprising:
latency,
throughput,
memory usage, and
error rates; and
the telemetry agent raises alerts upon crossing one or more pre-defined thresholds.

8. The system of claim 1, wherein the one or more processors execute the instructions to initiate automated rollbacks to a last known stable version upon detection of a deployment-induced anomaly.

9. The system of claim 1, wherein the one or more processors execute the instructions to:
update the shared memory context with metadata from one or more of:
successful pull requests,
failed deployments, and
run-time incidents.

10. A method for controlling software build, deployment, monitoring, and remediation operations in a cloud computing environment using one or more agents, wherein the one or more agents comprise:
a compile-time agent,
a build agent,
a run-time agent,
a corrective action agent, and
one or more telemetry agents,
the method comprising:
receiving a code commit event from a version control system;
generating or updating a pull request using the compile-time agent;
summarizing the code in the pull request and providing inline code review feedback;
performing code quality checks and static security and vulnerability assessments;
compiling source code and resolving dependencies using the build agent;
storing build artifacts with caching optimization;
generating and executing automated tests, wherein the tests are based on unit, integration, automation, and performance scenarios based on code changes;
provisioning cloud infrastructure using the run-time agent, wherein the provisioning is based on application requirements and infrastructure-as-code definitions;
deploying the compiled build to the provisioned environment using an adaptive deployment strategy;
provisioning domain names and digital certificates dynamically;
securing the deployed application through predefined policies and firewall rules;
monitoring the deployed application using one of the one or more telemetry agents;
detecting anomalies using machine learning models;
aggregating operational logs;
executing self-healing operations using the corrective action agent in response to detection of anomalies by the machine learning models;
storing operational and test feedback in a shared context memory; and
adapting, based on learning, at least one of the one or more agents using the stored feedback.

11. The method of claim 10, wherein:
the one or more agents comprise a code quality agent; and
the generating of the pull request further comprises evaluating, by the code quality agent, style conformance, cyclomatic complexity, and non-functional requirements.

12. The method of claim 10, wherein the compiling of the source code comprises:
detecting changed files,
identifying impacted modules, and
skipping redundant builds using intelligent dependency caching.

13. The method of claim 10, wherein the one or more agents comprises one or more synthetic data agents; and
the generating of the automated tests comprises:
analyzing historical bug trends; and
using at least one of the one or more synthetic data agents to generate high-risk edge-case scenarios.

14. The method of claim 10, wherein the provisioning cloud infrastructure further comprises selecting resource configurations that balance compute efficiency and cost constraints, based on telemetry-informed provisioning heuristics.

15. The method of claim 10, wherein the deploying the build further comprises selecting a deployment strategy based on deployment policy and live traffic load.

16. The method of claim 10, wherein the monitoring comprises collecting and analyzing, using at least one of the one or more telemetry agents, metrics comprising
latency,
throughput,
error rates, and
memory footprint.

17. The method of claim 10, wherein the executing self-healing operations comprises:
initiating automated rollback to a prior release,
restarting affected applications or infrastructure, and
provisioning additional infrastructure.

18. The method of claim 10, wherein the storing of the operational and test feedback into shared context comprises:
storing metadata comprising:
test coverage gaps,
code modules with frequent rollbacks, and
infrastructure scaling events, and
the method further comprises adjusting future pull request review strategies and provisioning logic accordingly.

19. The method of claim 10, wherein the adapting comprises:
adjusting at least one model or algorithm associated with at least one of the one or more agents using the learning; and
the adjusting enables improvement in a performance metric of the at least one model or algorithm.

20. The method of claim 19, wherein the learning is based on one or more of:
supervised learning,
unsupervised learning,
semi-supervised learning,
self-supervised learning,
reinforcement learning,
gradient-based learning,
transfer learning, and
fine-tuning of a pre-trained model.
